(19) United States
(12) Patent Application Publication
(10) Pub. No.: US 2026/0348293 A1
(43) Pub. Date: Nov. 5, 2026

(54) RADIAL FILM-RIDING SEAL ASSEMBLY

(71) Applicant: General Electric Company, Evendale, OH (US)

(72) Inventors: Rahul Anil Bidkar, Clifton Park, NY (US); Steven Douglas Johnson, Milford, OH (US); Suryanarayan Balaji, Schenectady, NY (US); Grant Robert Portune, Cincinnati, OH (US); Keith William Gary, Ballston Spa, NY (US)

(21) Appl. No.: 19/198,314

(22) Filed: May 5, 2025

(51) Int. Cl. F01D 11/02

(52) U.S. Cl. CPC F01D 11/025; F05D 2240/55

(57) ABSTRACT

A radial film-riding seal assembly includes a rotor defining an outer surface, a seal air supply, and a seal assembly sub-dividing a core air flowpath into a first pressure cavity pressurized at a first pressure, and a second pressure cavity pressurized at a lower second pressure. The seal assembly includes a plurality of seal segments arranged about the outer surface of the rotor. Each seal segment includes a seal block defining a radial load-bearing surface, an axial surface, a hydrostatic port defined along the radial load-bearing surface, and a fluid passage. A radial gap is defined between the radial load-bearing surface and the outer surface of the rotor. The fluid passage is fluidly coupled to the seal air supply. The seal air supply supplies a seal air to the fluid passage at a higher pressure than the first pressure and the second pressure.

### FIELD

The present disclosure generally relates to a rotary machine. More particularly, the subject matter described herein relates to radial film-riding seal assembly disposed between a rotating and a stationary component in a rotary machine.

### BACKGROUND

Turbine engines, and particularly gas or combustion turbine engines, are rotary machines that extract energy from a flow of combusted gases passing through the engine onto a multitude of rotating turbine blades. The turbine engine includes a plurality of rotating parts forming a rotor assembly and a plurality of stationary parts forming a stator assembly.

Radial film-riding seals are used to minimize leakage through a gap between two components, such as between the rotor assembly and the stator assembly, by restricting fluid flow from areas of higher pressure to areas of lower pressure. In addition, radial film-riding seals may compensate for transient variations that may exist in radial gaps between these components during operation of the turbine engine. Fluid leakage through the radial film-riding seals may significantly increase fuel consumption and adversely affect engine efficiency.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 illustrates a front perspective view of a seal assembly in conjunction with part of a rotary machine, according to at least one embodiment of the present disclosure.

FIG. 3 illustrates a side perspective view of a portion of the radial seal assembly including a portion of the seal segment and a portion of the rotor as shown in FIG. 2, according to an exemplary embodiment of the present disclosure.

FIG. 4 illustrates a side perspective view of a portion of the radial seal assembly including a portion of the seal segment and the rotor as shown in FIG. 2, according to another exemplary embodiment of the present disclosure.

FIG. 5 illustrates a side perspective view of a portion of the radial seal assembly including a portion of the seal segment as shown in FIG. 1, and the rotor as shown in FIG. 3, according to another exemplary embodiment of the present disclosure.

FIG. 6 illustrates a side perspective view of a portion of the radial seal assembly including a portion of the seal segment as shown in FIG. 2, and the rotor as shown in FIG. 3, according to another exemplary embodiment of the present disclosure.

FIG. 7 illustrates a side perspective view of a portion of the radial seal assembly including a portion of the seal segment as shown in FIG. 1, and the rotor as shown in FIG. 4, according to another exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The singular forms “a”, “an”, and “the” include plural references unless the context clearly dictates otherwise.

As used herein, the terms “first”, “second”, and “third” may be used interchangeably to distinguish one component from another and are not intended to signify location or importance of the individual components.

The term “at least one of” in the context of, e.g., “at least one of A, B, and C” refers to only A, only B, only C, or any combination of A, B, and C.

The terms “forward” and “aft” refer to relative positions within a gas turbine engine or vehicle and refer to the normal operational attitude of the gas turbine engine or vehicle. For example, with regards to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “immediately upstream” refers to a position directly before a point of reference, moving towards the source or origin of a flow of air or gas. It's the closest point in the opposite direction of the flow from the reference point.

The terms “coupled,” “fixed,” “attached to,” and the like refer to both direct coupling, fixing, or attaching, as well as indirect coupling, fixing, or attaching through one or more intermediate components or features, unless otherwise specified herein.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “plenum” refers to an air-filled space such as a cavity or volume defined within a core engine of a gas turbine engine or other rotary machine.

The terms “low” and “high”, or their respective comparative degrees (e.g., er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

Advanced air film seals operate at the lowest radial gaps possible at least in part due to air bearing stiffness generated by high pressure air that forms a curtain between a seal segment bearing face and rotating hardware such as a rotor or turbine shaft. For next generation engines, tighter gaps between stationary and rotating components utilize seals that can produce higher stiffness to reduce fluid leakage. The pressure to achieve the increased stiffness exceeds existing seal systems.

The present disclosure is generally directed to a radial seal assembly for a gas turbine engine. More particularly, this disclosure is directed to a segmented 3-pressure radial film-riding seal assembly. The radial film-riding seal assembly leverages a supply pressure fluid that provides hydrostatic pressurization to a radial film bearing defined between a radial load-bearing surface of a seal segment and an outer surface of a rotor shaft of the gas turbine engine. For the 3-pressure seal, the pressure of the supply pressure fluid is greater than the upstream and downstream pressure of gases flowing through a particular stage of the gas turbine engine. The supply pressure fluid is provided via direct connections to a supply fluid source such as an external seal air supply or through the rotor. The generated radial bearing film force allows the seal to ride at a set running gap to the rotor. This film acts as a seal between forward or upstream and aft or downstream pressure cavities defined within the compressor section or turbine section of the gas turbine engine. The radial seal assembly described herein may also use an aft frictional contact, aft bearing, or other axial film-bearing sealing solution.

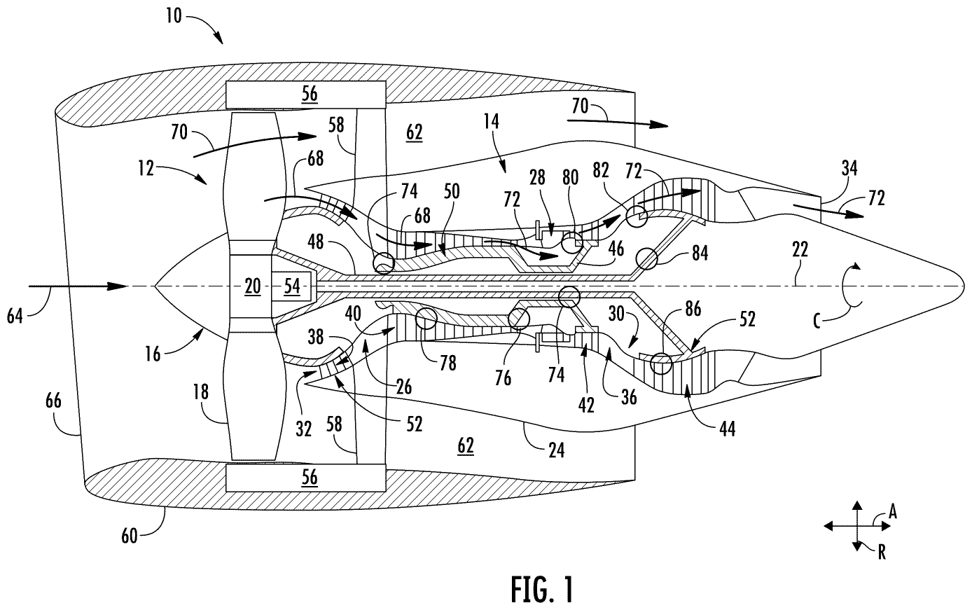

Referring now to the drawings, wherein identical numerals indicate the same elements throughout the figures, FIG. 1 illustrates an exemplary rotary machine configured as a gas turbine engine 10 as may incorporate various embodiments of the present disclosure. In some embodiments, the gas turbine engine 10 may be mounted to an aircraft, such as in an under-wing configuration or a tail-mounted configuration. The gas turbine engine 10 shown in FIG. 1 is provided by way of example and not to be limiting, and that the subject matter of the present disclosure may be implemented with other types of turbine engines, as well as other types of rotary machines.

In general, the gas turbine engine 10 may include a fan section 12 and a core engine 14 disposed downstream from the fan section 12. The fan section 12 may include a fan 16 with any suitable configuration, such as a variable pitch, single stage configuration. The fan 16 may include a plurality of fan blades 18 coupled to a fan disk 20 and spaced in a circumferentially spaced apart manner with respect to circumferential direction (C) defined about a longitudinal centerline 22 of the gas turbine engine 10. The longitudinal centerline 22 extends in axial direction (A). The plurality of fan blades 18 may extend outwardly from the fan disk 20 along radial direction (R) with respect to the longitudinal centerline 22. The core engine 14 may be coupled directly or indirectly to the fan section 12 to provide torque for driving the fan section 12.

The core engine 14 may include an engine case 24 that encases one or more portions of the core engine 14, including but not limited to, a compressor section 26, a combustor section 28, and a turbine section 30. The engine case 24 may at least partially define a core engine inlet 32, an exhaust nozzle 34, and a core air flowpath 36 therebetween. The core air flowpath 36 may pass through the compressor section 26, the combustor section 28, and the turbine section 30. The compressor section 26 may include a booster or low-pressure compressor 38 and a high-pressure compressor 40 disposed downstream from the low-pressure compressor 38. The turbine section 30 may include a high-pressure turbine 42 and a low-pressure turbine 44. The compressor section 26, the combustor section 28, turbine section 30, and the exhaust nozzle 34 may be arranged in serial flow relationship along the longitudinal centerline 22 and may respectively define a portion of the core air flowpath 36 through the core engine 14.

The core engine 14 and the fan section 12 may be coupled to a shaft driven by the core engine 14. By way of example, as shown in FIG. 1, the core engine 14 may include a high-pressure shaft 46 and a low-pressure shaft 48. The high-pressure shaft 46 may drivingly connect the high-pressure turbine 42 to the high-pressure compressor 40. The low-pressure shaft 48 may drivingly connect the low-pressure turbine 44 to the low-pressure compressor 38. In other embodiments, a turbine engine may have three shafts, such as in the case of a turbine engine that includes an intermediate pressure turbine. A shaft of the core engine 14, together with a rotating portion of the core engine 14, may sometimes be referred to as a “spool.” The high-pressure shaft 46, a rotating portion of the high-pressure compressor 40 that is coupled to the high-pressure shaft 46, and a rotating portion of the high-pressure turbine 42 coupled to the high-pressure shaft 46, may be collectively referred to as a high-pressure spool 50. The low-pressure shaft 48, a rotating portion of the low-pressure compressor 38 coupled to the low-pressure shaft 48, and a rotating portion of the low-pressure turbine 44 coupled to the low-pressure shaft 48, may be collectively referred to as a low-pressure spool 52.

In some embodiments, the fan section 12 may be coupled directly to a shaft of the core engine 14, such as directly to the low-pressure shaft 48. Alternatively, as shown in FIG. 1, the fan section 12 and the core engine 14 may be coupled to one another by way of a power gearbox 54, such as a planetary reduction gearbox, an epicyclical gearbox, or the like. For example, the power gearbox 54 may couple the low-pressure shaft 48 to the fan 16, such as to the fan disk 20 of the fan section 12. The power gearbox 54 may include a plurality of gears for stepping down the rotational speed of the low-pressure shaft 48 to a more efficient rotational speed for the fan section 12.

Still referring to FIG. 1, the fan section 12 of the gas turbine engine 10 may include a fan case 56 that at least partially surrounds the fan 16 and/or the plurality of fan blades 18. The fan case 56 may be supported by the core engine 14, for example, by a plurality of outlet guide vanes 58 circumferentially spaced and extending substantially radially therebetween. The gas turbine engine 10 may include a nacelle 60. The nacelle 60 may be secured to the fan case 56. The nacelle 60 may include one or more sections that at least partially surround the fan section 12, the fan case 56, and/or the core engine 14. For example, the nacelle 60 may include a nose cowl, a fan cowl, an engine cowl, a thrust reverser, and so forth. The fan case 56 and/or an inward portion of the nacelle 60 may circumferentially surround an outer portion of the core engine 14. The fan case 56 and/or the inward portion of the nacelle 60 may define a bypass passage 62. The bypass passage 62 may be disposed annularly between an outer portion of the core engine 14 and the fan case 56 and/or inward portion of the nacelle 60 surrounding the outer portion of the core engine 14.

During operation of the gas turbine engine 10, an inlet airflow 64 enters the gas turbine engine 10 through an inlet 66 defined by the nacelle 60, such as by a nose cowl of the nacelle 60. The inlet airflow 64 passes across the plurality of fan blades 18. The inlet airflow 64 splits into a core airflow 68 that flows into and through the core air flowpath 36 of the core engine 14, and a bypass airflow 70 that flows through the bypass passage 62. The core airflow 68 is compressed by the compressor section 26. Pressurized air from the compressor section 26 flows downstream to the combustor section 28 where fuel is introduced to generate combustion gases 72. The combustion gases 72 exit the combustor section 28 and flow through the turbine section 30, generating torque that rotates the compressor section 26 to support combustion while also rotating the fan section 12. Rotation of the fan section 12 causes the bypass airflow 70 to flow through the bypass passage 62, generating propulsive thrust. Additional thrust is generated by the combustion gases 72 exiting the exhaust nozzle 34.

The various features and attributes of the gas turbine engine 10 described with reference to FIG. 1 are provided by way of example only and not to be limiting. In fact, the present disclosure may be implemented with respect to any turbine engine, including those with attributes or features that differ in one or more respects from the gas turbine engine 10 described herein.

Still referring to FIG. 1, the gas turbine engine 10 includes one or more seal assemblies disposed at a number of locations throughout the gas turbine engine 10, any one or more of which may be configured according to the present disclosure. A presently disclosed seal assembly may be provided in gas turbine engine 10 at any location that includes an interface with a rotating portion of the gas turbine engine 10, such as an interface with a rotating portion or spool of the core engine 14. For example, a seal assembly may be included at an interface with a portion of the low-pressure spool 52 and/or at an interface with the high-pressure spool 50. In some embodiments, a seal assembly may be included at an interface between a spool, such as the low-pressure spool 52 or the high-pressure spool 50, and a stationary portion of the core engine 14.

Additionally, or in the alternative, a seal assembly may be included at an interface between the low-pressure spool 52 and the high-pressure spool 50. Additionally, or in the alternative, a seal assembly may be included at an interface between a stationary portion of the core engine 14 and the low-pressure shaft 48 or the high-pressure shaft 46, and/or at an interface between the low-pressure shaft 48 and the high-pressure shaft 46.

By way of example, FIG. 1 shows some exemplary locations of a seal assembly. As one example, a seal assembly may be located at or near a bearing compartment 74. A seal assembly located at or near the bearing compartment 74 may sometimes be referred to as a bearing compartment seal. Such a bearing compartment seal may be configured to inhibit air flow, such as core airflow 68 from passing into the bearing compartment 74 of the gas turbine engine 10, such as the bearing compartment 74 located at an interface between the low-pressure shaft 48 and the high-pressure shaft 46.

As another example, a seal assembly may be located at or near the compressor section 26 of the gas turbine engine 10. In some embodiments, a seal assembly may be located at or near a compressor discharge 76, for example, of the high-pressure compressor 40. A seal assembly located at or near the compressor discharge 76 may sometimes be referred to as a compressor discharge pressure seal. Such a compressor discharge pressure seal may be configured to maintain pressure downstream of the compressor section 26 and/or to provide bearing thrust balance.

Additionally, or in the alternative, a seal assembly may be located between adjacent compressor stages 78 of the compressor section 26. A seal assembly located between adjacent compressor stages 78 may be sometimes referred to as a compressor interstage seal. Such a compressor interstage seal may be configured to limit air recirculation within the compressor section 26.

As another example, a seal assembly may be located at or near the turbine section 30 of the gas turbine engine 10. In some embodiments, a seal assembly may be located near one or both of an inlet 80 to the high-pressure turbine 42. In addition, or alternatively, a seal assembly may be located near one or both of an inlet 82 to the low-pressure turbine 44. A seal assembly located at or near inlet 80 or inlet 82 may sometimes be referred to as a forward turbine seal. Such a forward turbine seal may be configured to contain high-pressure cooling air for the high-pressure turbine 42 and/or the low-pressure turbine 44, such as for turbine disks and turbine blades thereof.

Additionally, or in the alternative, a seal assembly may be located at or near one or more turbine disk rims 84. A seal assembly located at or near the turbine disk rim 84 may sometimes be referred to as a turbine disk rim seal. Such a turbine disk rim seal may be configured to inhibit hot gas ingestion into the disk rim area.

Additionally, or in the alternative, a seal assembly may be located between adjacent turbine stages 86 of the turbine section 30. A seal assembly located between adjacent turbine stages 86 may be sometimes referred to as a turbine interstage seal. Such a turbine interstage seal may be configured to limit air recirculation within the turbine section 30.

A seal assembly at any one or more of these locations or other location of the gas turbine engine 10 may be configured in accordance with the present disclosure. Additionally, or in the alternative, the gas turbine engine 10 may include a presently disclosed seal assembly at one or more other locations of the gas turbine engine 10. The presently disclosed seal assemblies may also be used in other rotary machines. The gas turbine engine 10, described with reference to FIG. 1, is provided by way of example and not to be limiting. The presently disclosed seal assemblies may be included in any rotary machine, such as the gas turbine engine 10.

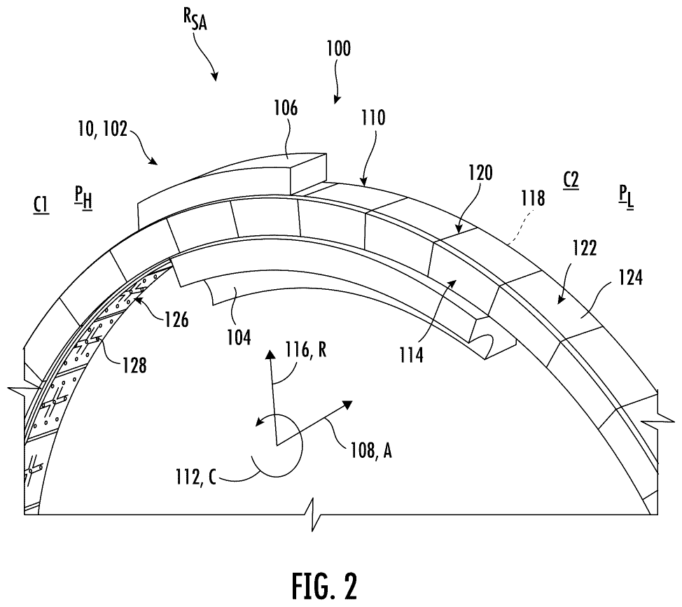

FIG. 2 illustrates a front perspective view of a seal assembly 100 in conjunction with part of a rotary machine 102 such as but not limited to the gas turbine engine 10 shown in FIG. 1. The rotary machine 102 includes a moveable (e.g., rotating) stepped rotor referred to herein as “rotor 104” and a stationary housing referred to herein as “stator 106”. The seal assembly 100 and the rotary machine 102, particularly the rotor 104 together at least partially form a radial film-riding seal assembly (indicated as R_{SA} throughout the figures) for the gas turbine engine 10 (FIG. 1). In exemplary embodiments, the stator 106 may comprise a stator assembly (not shown) including stator vanes or blades and associated mounting hardware. In exemplary embodiments, the rotor 104 may comprise the high-pressure shaft 46 (FIG. 1) or the low-pressure shaft 48 (FIG. 1). The rotor 104 rotates relative to the stator 106 and the seal assembly 100 by rotating around or about an axis of rotation 108. In exemplary embodiments, the axis of rotation 108 coincides with or extends parallel to the axial direction A and more particularly the longitudinal centerline 22 of the gas turbine engine 10, as shown in FIG. 1 and FIG. 2 collectively.

As shown in FIG. 2, the seal assembly 100 is formed by a plurality of seal segments 110 arranged circumferentially around the axis of rotation 108 along a circumferential direction 112 and between the rotor 104 and stator 106. Circumferential direction 112 may coincide with circumferential direction C shown in FIG. 1. The seal assembly 100 is disposed within the core air flowpath 36 and at least partially serves to sub-divide the core air flowpath 36 into a first pressure cavity (C1) that is defined immediately upstream of the seal assembly 100 and a second pressure cavity (C2) defined immediately downstream of the seal assembly 100 in the rotary machine 102. As shown in FIG. 2, the seal assembly 100 is used to reduce or minimize (e.g., eliminate) leakage of fluid (e.g., working fluid, exhaust or other gases) between the first pressure cavity C1 (e.g., along the axial direction A shown in FIG. 1) and the second pressure cavity (C2) (e.g., along the axial direction A).

In operation, higher-pressure fluid (indicated as P_{H} throughout the figures) pressurizes the first pressure cavity C1 and passes along the axis of rotation 108 or axial direction A to the second pressure cavity C2 as lower-pressure fluid (indicated as P_{L} throughout the figures) and pressurizes the second pressure cavity C2 at a lower pressure than the first pressure cavity C1. In exemplary embodiments, front cover plates 114 of each seal segment 110 face the higher-pressure fluid P_{H} in the first pressure cavity C1.

In particular embodiments, the seal segments 110 may not include a front cover plate 114. The front cover plates 114 are radially oriented in that the front cover plates 114 radially extend between stator 106 and the rotor 104 (e.g., extend along radial direction 116). In exemplary embodiments, radial direction 116 coincides with or extends parallel to the radial direction R of the gas turbine engine 10 shown in FIG. 1. In particular embodiments, each seal segment 110 may include a backing plate 118 (not visible in FIG. 2) that faces the lower-pressure fluid P_{L} in the second pressure cavity C2.

In exemplary embodiments, the seal segments 110 are arranged circumferentially adjacent and are separated by a small intersegment gap 120 that allows for free motion of the seal segments 110 relative to each other (predominantly in the radial direction 116) of each seal segment 110, which is unaffected by the circumferentially neighboring seal segments 110. In exemplary embodiments, each seal segment 110 includes a top plate 122 defining a stator interface surface 124 that faces and/or directly engages the stator 106 and a radial load-bearing surface 126 that faces the rotor 104. The stator interface surface 124 can be used for attaching (e.g., by bolting, brazing, or welding) each seal segment 110 to the stator 106. The radial load-bearing surface 126 is part of a seal shoe or seal block of the seal segment 110, as described herein. In exemplary embodiments, the radial load-bearing surfaces 126 can include a plurality of hydrostatic ports 128. In exemplary embodiments, radial load-bearing surfaces 126 may include hydrodynamic features such as grooves or channels.

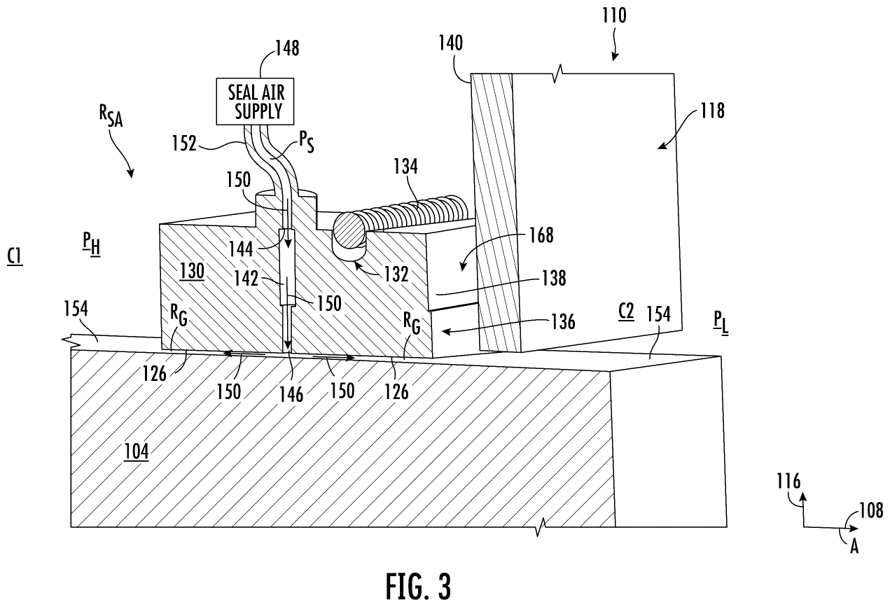

FIG. 3 illustrates a side perspective view of a portion of the radial film-riding seal assembly R_{SA} including a portion of the seal segment 110 and a portion of the rotor 104 as shown in FIG. 2, according to an exemplary embodiment of the present disclosure. In the exemplary embodiment shown in FIG. 3, the seal segment 110 includes a seal block 130. The seal block 130 at least partially defines the radial load-bearing surface 126. It is to be appreciated that each seal segment 110 of the seal assembly 100 (FIG. 2) includes at least one seal block 130.

In exemplary embodiments, each seal block 130 includes an elongated recess 132 that extends along or parallel to the circumferential direction 112. The elongated recess 132 may be formed or configured to receive a biasing element 134 such as a garter spring or multiple garter springs. The biasing element 134 radially biases the seal block 130, particularly the radial load-bearing surface 126, radially inward towards the rotor 104. In addition, or in the alternative, the biasing element 134 may link together some or all seal blocks 130 arranged circumferentially adjacent to form a ring of seal blocks.

As shown in FIG. 3, the seal block 130 includes or defines a radial wall 136. The radial wall 136 defines or at least partially defines an axial load-bearing surface 138. The axial load-bearing surface 138 faces and is disposed proximate to an inner surface 140 of the backing plate 118. As used herein, the term “proximate to” infers that an object or feature is physically near or close to another object or feature. In exemplary embodiments, the radial wall 136, or more particularly the axial load-bearing surface 138, may be stepped 168.

In the exemplary embodiment shown in FIG. 3, the seal block 130 includes or defines a fluid passage 142. The fluid passage 142 provides for fluid communication between an inlet 144 to the fluid passage 142 and at least one hydrostatic port 146 of the plurality of hydrostatic ports 128 shown in FIG. 2. The inlet 144 is fluidly coupled to a seal air supply 148. The seal air supply 148 may include a compressed air supply that is external to the gas turbine engine 10 (FIG. 1) such as, but not limited to, a pressurized tank or an auxiliary turbine engine (not shown). In other embodiments, the seal air supply 148 may include (e.g., be fluidly coupled to) one or more of the high-pressure compressor 40, the low-pressure compressor 38, the high-pressure turbine 42, and the low-pressure turbine 44 (FIG. 1).

The seal air supply 148 provides seal air 150 to the fluid passage 142 at a supply pressure (indicated as P_{S} throughout the Figures) that is higher than both the higher-pressure fluid P_{H} in the first pressure cavity C1 and the lower-pressure fluid P_{L} in the second pressure cavity C2. This typically means that a ratio P_{S}/P_{H} can range from low values on the order of 1 (example P_{S}/P_{H} ratio 1.5) through higher values such as on the order of 10 (example P_{S}/P_{H} ratio 30). In exemplary embodiments, the seal air supply 148 is fluidly coupled to the fluid passage 142, particularly the inlet 144, via a tube 152. The tube 152 may extend within and may extend externally from the gas turbine engine 10 (FIG. 1).

In operation, the seal air supply 148 provides the seal air 150 at the supply pressure P_{S} to the fluid passage 142 defined within the seal block 130. The seal air 150 passes through the fluid passage 142 and is exhausted through the at least one hydrostatic port 146. The at least one hydrostatic port 146 directs the seal air 150 between the radial load-bearing surface 126 and an outer surface 154 of the rotor 104 to allow the seal block 130 (and the seal assembly 100) to float above the outer surface 154 of the rotor 104 while maintaining a radial seal and a radial gap (indicated as R_{G} throughout the Figures) between the seal assembly 100 and the rotor 104 to avoid wearing down the seal block 130 and to prevent or reduce passage of the higher-pressure fluid P_{H} through the radial gap R_{G} from the first pressure cavity C1 to the second pressure cavity C2.

The higher-pressure fluid P_{H} and other transient conditions may act to push or bias the seal block 130. The higher-pressure fluid P_{H} in the first pressure cavity C1 fills the recessed step 168 and balances a majority of an axial biasing load on the seal block 130. The unbalanced portion of the axial biasing load causes the seal block 130 to contact against the inner surface 140 of the backing plate 118. The contact region between the seal block 130 and backing plate 118 have physical contact with some air leaking between the first pressure cavity C1 and the second pressure cavity C2.

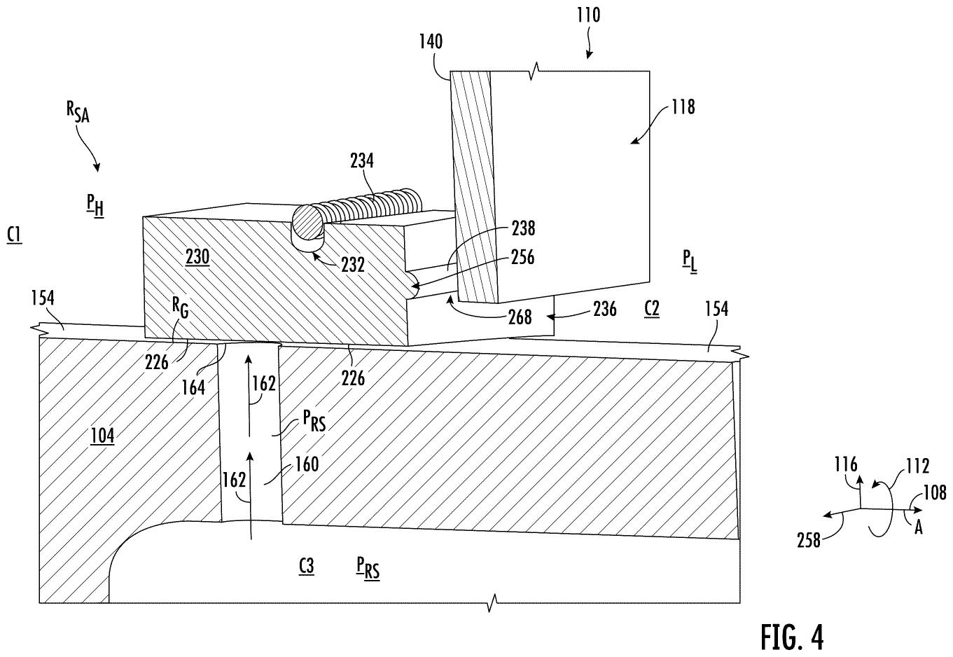

FIG. 4 illustrates a side perspective view of a portion of the radial film-riding seal assembly R_{SA} including a portion of the seal segment 110 and the rotor 104 as shown in FIG. 2, according to another exemplary embodiment of the present disclosure. In the exemplary embodiment shown in FIG. 4, the seal segment 110 includes a seal block 230. The seal block 230 defines a radial load-bearing surface 226. In exemplary embodiments, each seal segment 110 of the seal assembly 100 (FIG. 2) includes at least one seal block 230.

In exemplary embodiments, each seal block 230 includes an elongated recess 232 that extends along or parallel to the circumferential direction 112. The elongated recess 232 may be formed or configured to receive a biasing element 234 such as a garter spring or multiple garter springs. The biasing element 234 radially biases the seal block 230, particularly the radial load-bearing surface 226, radially inward with respect to radial direction 116 towards the outer surface 154 of the rotor 104. In addition, or in the alternative, the biasing element 234 may link together some or all seal blocks 230 arranged circumferentially adjacent to form a ring of seal blocks 230 about the outer surface 154 of the rotor 104.

As shown in FIG. 4, the seal block 230 includes or defines a radial wall 236. The radial wall 236 defines or at least partially defines an axial surface or axial load-bearing surface 238. The axial load-bearing surface 238 faces and is disposed proximate to the inner surface 140 of the backing plate 118. In exemplary embodiments, the radial wall 236, or more particularly the axial load-bearing surface 238, defines a chordal bump 256 that extends in a tangential direction 258 with respect to the axis of rotation 108 or axial direction A and the radial direction 116 across the radial wall 236 and the axial load-bearing surface 238. The chordal bump 256 at least partially defines the axial load-bearing surface 238.

In the embodiment shown in FIG. 4, the rotor 104 defines a rotor fluid passage 160 and at least partially defines an inner rotor cavity (C3). The inner rotor cavity C3 is defined radially inwardly with respect to radial direction 116 from the outer surface 154 of the rotor 104. The rotor fluid passage 160 provides for fluid communication between the inner rotor cavity C3 and the radial gap R_{G} defined between the radial load-bearing surface 226 and the outer surface 154 of the rotor 104. The inner rotor cavity C3 provides rotor seal air 162 to the rotor fluid passage 160 and to the radial gap R_{G} at an inner rotor supply pressure (indicated as P_{RS} throughout the Figures) that is higher than the higher-pressure fluid P_{H} in the first pressure cavity C1 and the lower-pressure fluid P_{L} in the second pressure cavity C2. This typically means that a ratio P_{RS}/P_{H} can range from low values on the order of 1 (example P_{RS}/P_{H} ratio 1.5) through higher values on the order of 10 (example P_{RS}/P_{H} ratio 30). The inner rotor cavity C3 may receive the rotor seal air 162 from the gas turbine engine 10 (FIG. 1) such as, but not limited to, one or more of the high-pressure compressor 40, the low-pressure compressor 38, the high-pressure turbine 42, and the low-pressure turbine 44, as shown in FIG. 1.

In operation, as shown in FIG. 4, the inner rotor cavity C3 is charged with the rotor seal air 162 at the inner rotor supply pressure P_{RS} by one or more of the high-pressure compressor 40, the low-pressure compressor 38, the high-pressure turbine 42, and the low-pressure turbine 44. The rotor seal air 162 flows from the inner rotor cavity C3 through the rotor fluid passage 160 and is exhausted via an rotor seal outlet 164 of the rotor fluid passage 160 between the radial load-bearing surface 226 and the outer surface 154 of the rotor 104 to allow the seal block 230 (and the seal assembly 100) to float above the outer surface 154 of the rotor 104 while maintaining a radial seal and the radial gap R_{G} between the seal assembly 100 and the rotor 104. The radial gap R_{G} acts to avoid wear of the seal block 230 against the outer surface 154 of the rotor. The rotor seal air 162 at the inner rotor supply pressure P_{RS} prevents or reduces passage of the higher-pressure fluid P_{H} through the radial gap R_{G} from the first pressure cavity C1 to the second pressure cavity C2.

The higher-pressure fluid P_{H} and other transient conditions may act to push or bias the seal block 230, more particularly the axial load-bearing surface 238, against the inner surface 140 of the backing plate 118, thus forming a physical contact with the backing plate 118 with air leakage across an axial film-bearing seal 268 formed between the first pressure cavity C1 and the second pressure cavity C2. The chordal bump 256 may allow for relative movement in one or both of the radial direction 116 and about the axis of rotation 108 while maintaining contact between the axial load-bearing surface 238 and the inner surface 140 of the backing plate 118. In addition, or in the alternative, the axial film-bearing seal 268 may prevent undesirable rubbing and wear between the axial load-bearing surface 238 and the inner surface 140 of the backing plate 118.

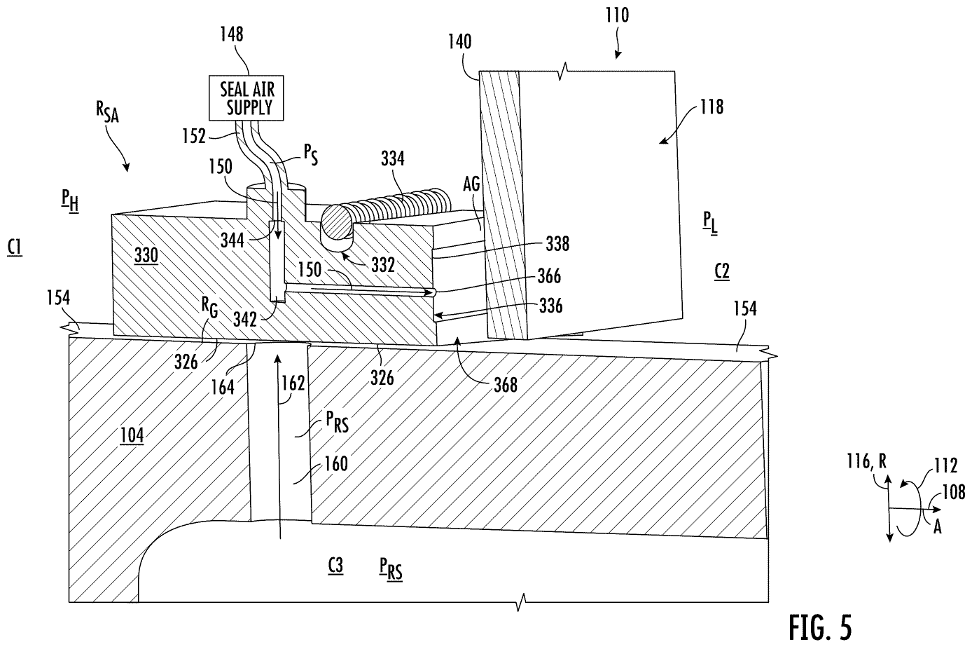

FIG. 5 illustrates a side perspective view of a portion of the radial film-riding seal assembly R_{SA} including a portion of the seal segment 110 as shown in FIG. 1, and the rotor 104 as shown in FIG. 3, according to another exemplary embodiment of the present disclosure. In the exemplary embodiment shown in FIG. 5, the seal segment 110 includes a seal block 330. The seal block 330 defines a radial load-bearing surface 326. It is to be appreciated that, in exemplary embodiments, each seal segment 110 of the seal assembly 100 (FIG. 2) includes at least one seal block 330.

As shown in FIG. 5, each seal block 330 includes an elongated recess 332 that extends along or parallel to the circumferential direction 112. The elongated recess 332 may be formed or configured to receive a biasing element 334 such as a garter spring or multiple garter springs. The biasing element 334 radially biases the seal block 330, particularly the radial load-bearing surface 326, radially inward with respect to radial direction 116 towards the outer surface 154 of the rotor 104. In addition, or in the alternative, the biasing element 334 may link together some or all seal blocks 330 arranged circumferentially adjacent to form a ring of seal blocks about the outer surface 154 of the rotor 104.

As shown in FIG. 5, the seal block 330 includes or defines a radial wall 336. The radial wall 336 defines or at least partially defines an axial surface 338. The axial surface 338 faces and is disposed proximate to the inner surface 140 of the backing plate 118. The axial surface 338 is recessed from the radial wall 336.

In the exemplary embodiment shown in FIG. 5, the seal block 330 includes or defines a fluid passage 342. The fluid passage 342 provides for fluid communication between an inlet 344 to the fluid passage 342 to a hydrostatic port 366 disposed along the radial wall 336, particularly along the axial surface 338. Although one hydrostatic port 366 is shown, it is to be appreciated that the seal block 330 may include a plurality of hydrostatic ports disposed along the radial wall 336, particularly along the axial surface 338. The inlet 344 is fluidly coupled to a seal air supply 148. The seal air supply 148 may include a compressed air supply that is external to the gas turbine engine 10 (FIG. 1) such as, but not limited to, a pressurized tank or an auxiliary turbine engine (not shown). In other embodiments, the seal air supply 148 may include (e.g., be fluidly coupled to) one or more of the high-pressure compressor 40, the low-pressure compressor 38, the high-pressure turbine 42, and the low-pressure turbine 44.

The seal air supply 148 provides seal air 150 to the fluid passage 342 at supply pressure P_{S} that is higher than the higher-pressure fluid P_{H} in the first pressure cavity C1 and the lower-pressure fluid P_{L} in the second pressure cavity C2. This typically means that a ratio P_{S}/P_{H} can range from low values of the order of 1 (example P_{S}/P_{H} ratio 1.5) through high values such of the order of 10 (example Pₛ/P_{H} ratio 30). In exemplary embodiments, the seal air supply 148 is fluidly coupled to the fluid passage 342, particularly the inlet 344, via tube 152. The tube 152 may extend within and may extend externally from the gas turbine engine 10 (FIG. 1).

In the embodiment shown in FIG. 5, the rotor 104 defines the rotor fluid passage 160 and at least partially defines the inner rotor cavity C3. The rotor fluid passage 160 provides for fluid communication between the inner rotor cavity C3 and the radial gap R_{G} defined between the radial load-bearing surface 326 and the outer surface 154 of the rotor 104. The inner rotor cavity C3 provides rotor seal air 162 to the rotor fluid passage 160 and to the radial gap R_{G} at the inner rotor supply pressure P_{RS} that is higher than the higher-pressure fluid P_{H} in the first pressure cavity C1 and the lower-pressure fluid P_{L} in the second pressure cavity C2. This typically means that the ratio P_{RS}/P_{H} can range from low values of the order of 1 (example P_{RS}/P_{H} ratio 1.5) through high values such of the order of 10 (example P_{RS}/P_{H} ratio 30). The inner rotor cavity C3 may receive the rotor seal air 162 from the gas turbine engine 10 (FIG. 1) such as, but not limited to, one or more of the high-pressure compressor 40, the low-pressure compressor 38, the high-pressure turbine 42, and the low-pressure turbine 44, as shown in FIG. 1.

In operation, as shown in FIG. 5, the inner rotor cavity C3 is charged with the rotor seal air 162 at the inner rotor supply pressure P_{RS} by one or more of the high-pressure compressor 40, the low-pressure compressor 38, the high-pressure turbine 42, and the low-pressure turbine 44 (FIG. 1). The rotor seal air 162 flows from the inner rotor cavity C3 through the rotor fluid passage 160 and is exhausted via an rotor seal outlet 164 of the rotor fluid passage 160 between the radial load-bearing surface 326 and the outer surface 154 of the rotor 104 to allow the seal block 330 (and the seal assembly 100) to float above the outer surface 154 of the rotor 104 while maintaining a radial seal and the minimum radial gap R_{G} between the seal assembly 100 and the rotor 104. The minimum radial gap R_{G} acts to avoid wear of the seal block 330 against the outer surface 154 of the rotor 104. The rotor seal air 162 at the inner rotor supply pressure P_{RS} prevents or reduces passage of the higher-pressure fluid P_{H} through the radial gap R_{G} from the first pressure cavity C1 to the second pressure cavity C2.

The higher-pressure fluid P_{H} in the first pressure cavity C1 and other transient conditions may act to push or bias the seal block 330, more particularly the axial surface 338, towards the inner surface 140 of the backing plate 118. The seal air supply 148 provides the seal air 150 to the fluid passage 342 via the tube 152. The seal air 150 is exhausted from the hydrostatic port 366 between the axial surface 338 and the inner surface 140 of the backing plate, thereby forming an axial film-bearing seal 368 therebetween. The axial film-bearing seal 368 may also be referred to as an axial seal. The axial film-bearing seal 368 further prevents or reduces passage of the higher-pressure fluid P_{H} from the first pressure cavity C1 to the second pressure cavity C2 between the axial surface 338 and the inner surface 140 of the backing plate 118. In addition, or in the alternative, the axial film-bearing seal 368 may prevent undesirable rubbing and wear between the axial surface 338 and the inner surface 140 of the backing plate 118, because it is levitating on an air film.

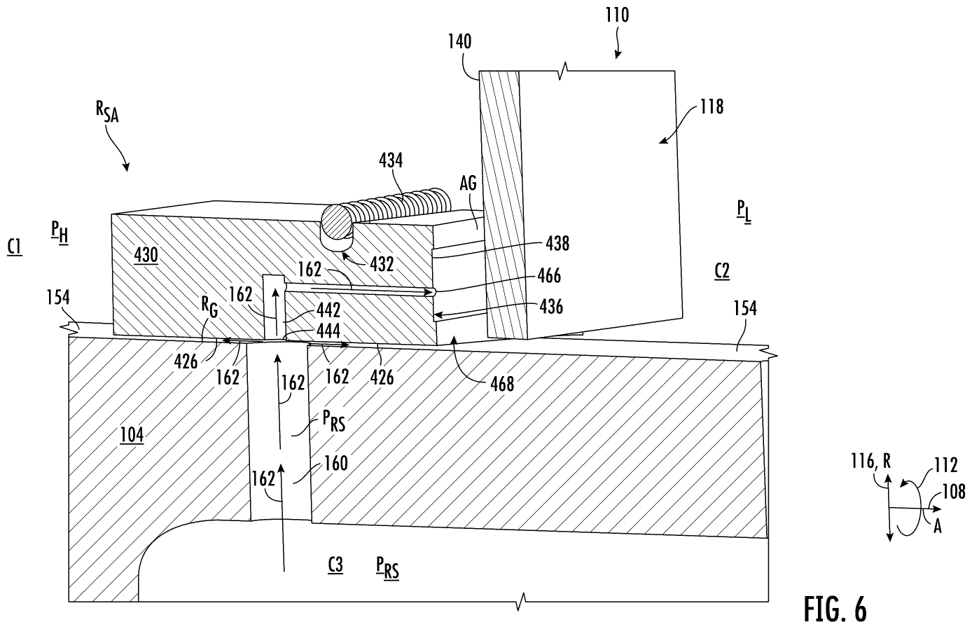

FIG. 6 illustrates a side perspective view of a portion of the radial film-riding seal assembly R_{SA} including a portion of the seal segment 110 as shown in FIG. 2, and the rotor 104 as shown in FIG. 3, according to another exemplary embodiment of the present disclosure. In the exemplary embodiment shown in FIG. 6, the seal segment 110 includes a seal block 430. The seal block 430 defines a radial load-bearing surface 426. It is to be appreciated that in exemplary embodiments each seal segment 110 of the seal assembly 100 (FIG. 2) includes at least one seal block 430.

In exemplary embodiments, each seal block 430 includes an elongated recess 432 that extends along or parallel to the circumferential direction 112. The elongated recess 432 may be formed or configured to receive a biasing element 434 such as a garter spring or multiple garter springs. The biasing element 434 radially biases the seal block 430, particularly the radial load-bearing surface 426, radially inward with respect to radial direction 116 towards the outer surface 154 of the rotor 104. In addition, or in the alternative, the biasing element 434 may link together some or all seal blocks 430 arranged circumferentially adjacent to form a ring of seal blocks about the outer surface 154 of the rotor 104.

As shown in FIG. 6, the seal block 430 includes or defines a radial wall 436. The radial wall 436 defines or at least partially defines an axial surface 438, which is recessed from the radial wall 436. The axial surface 438 faces and is disposed proximate to the inner surface 140 of the backing plate 118.

In the exemplary embodiment shown in FIG. 6, the seal block 430 includes or defines a fluid passage 442. The fluid passage 442 provides for fluid communication between an inlet 444 defined along the radial load-bearing surface 426, to the fluid passage 442, and to a hydrostatic port 466 defined or disposed along the radial wall 436, particularly along the axial surface 438. Although one hydrostatic port 466 is shown, it is to be appreciated that the seal block 430 may include a plurality of hydrostatic ports disposed along the radial wall 436, particularly along the axial surface 438.

In the embodiment shown in FIG. 6, the rotor 104 defines the rotor fluid passage 160 and at least partially defines the inner rotor cavity C3. The rotor fluid passage 160 provides for fluid communication between the inner rotor cavity C3 and the radial gap R_{G} defined between the radial load-bearing surface 426 and the outer surface 154 of the rotor 104. The inner rotor cavity C3 provides rotor seal air 162 to the rotor fluid passage 160 and to the radial gap R_{G} at the inner rotor supply pressure P_{RS} that is higher than the higher-pressure fluid P_{H} in the first pressure cavity C1 and the lower-pressure fluid P_{L} in the second pressure cavity C2. This typically means that a ratio P_{RS}/P_{H} can range from low values of the order of 1 (example P_{RS}/P_{H} ratio 1.5) through high values such of the order of 10 (example P_{RS}/P_{H} ratio 30). The inner rotor cavity C3 may receive the rotor seal air 162 from the gas turbine engine 10 (FIG. 1) such as, but not limited to, one or more of the high-pressure compressor 40, the low-pressure compressor 38, the high-pressure turbine 42, and the low-pressure turbine 44, as shown in FIG. 1.

In operation, as shown in FIG. 6, the inner rotor cavity C3 is charged with the rotor seal air 162 at the inner rotor supply pressure P_{RS} by one or more of the high-pressure compressor 40, the low-pressure compressor 38, the high-pressure turbine 42, and the low-pressure turbine 44. The rotor seal air 162 flows from the inner rotor cavity C3 through the rotor fluid passage 160 and is exhausted via rotor seal outlet 164 of the rotor fluid passage 160 between the radial load-bearing surface 426 and the outer surface 154 of the rotor 104 to allow the seal block 430 (and the seal assembly 100) to float above the outer surface 154 of the rotor 104 while maintaining a radial seal and the minimum radial gap R_{G} between the seal assembly 100 and the rotor 104. The minimum radial gap R_{G} acts to avoid wear of the seal block 430 against the outer surface 154 of the rotor 104. The rotor seal air 162 at the inner rotor supply pressure P_{RS} prevents or reduces passage of the higher-pressure fluid P_{H} through the radial gap R_{G} from the first pressure cavity C1 to the second pressure cavity C2.

As shown in FIG. 6, a portion of the rotor seal air 162 enters the fluid passage 442 of the seal block 430 via inlet 444 and is exhausted from the hydrostatic port 466 between the axial surface 438 and the inner surface 140 of the backing plate, thereby forming an axial film-bearing seal 468 therebetween. The axial film-bearing seal 468 may also be referred to as an axial seal. The axial film-bearing seal 468 further prevents or reduces passage of the higher-pressure fluid P_{H} from the first pressure cavity C1 to the second pressure cavity C2 between the axial surface 438 and the inner surface 140 of the backing plate 118. In addition, or in the alternative, the axial film-bearing seal 468 may prevent undesirable rubbing and wear between the radial wall 436 and the inner surface 140 of the backing plate 118.

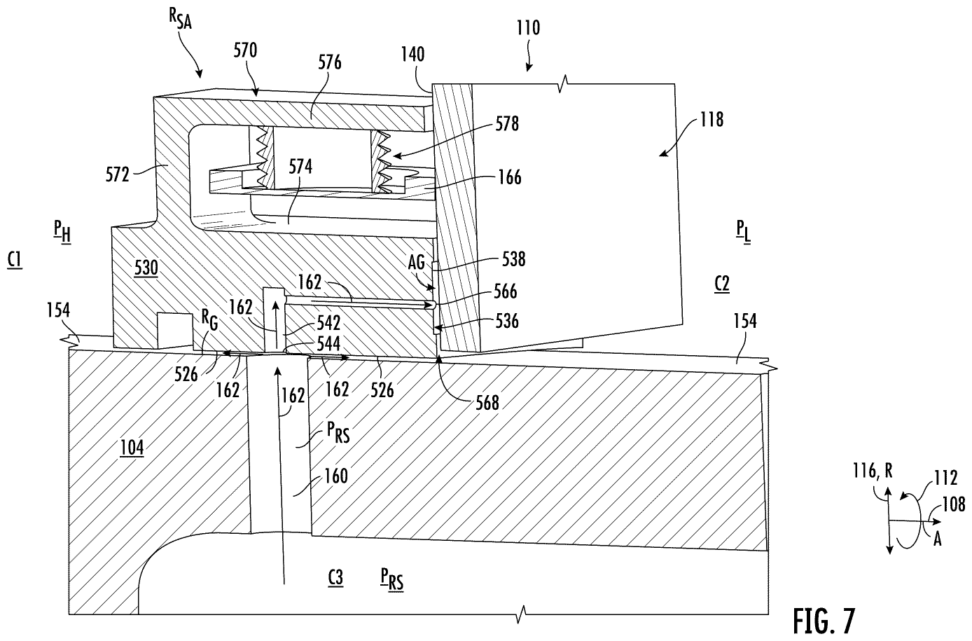

FIG. 7 illustrates a side perspective view of a portion of the radial film-riding seal assembly R_{SA} including a portion of the seal segment 110 as shown in FIG. 1, and the rotor 104 as shown in FIG. 4, according to another exemplary embodiment of the present disclosure. In the exemplary embodiment shown in FIG. 7, the seal segment 110 includes a seal block 530. The seal block 530 defines a radial load-bearing surface 526. It is to be appreciated that, in exemplary embodiments, each seal segment 110 of the seal assembly 100 (FIG. 2) includes at least one seal block 530.

As shown in FIG. 7, the seal block 530 includes or defines a radial wall 536. The radial wall 536 defines or at least partially defines an axial surface 538. The axial surface 538 faces and is disposed proximate to the inner surface 140 of the backing plate 118. Axial surface 538 is recessed from the radial wall 536.

In the exemplary embodiment shown in FIG. 7, the seal block 530 includes or defines a fluid passage 542. The fluid passage 542 provides for fluid communication between an inlet 544 defined along the radial load-bearing surface 526, and a hydrostatic port 566 defined or disposed along the radial wall 536, particularly along the axial surface 538. Although one hydrostatic port 566 is shown for illustration, it is to be appreciated that the seal block 530 may include a plurality of hydrostatic ports defined or disposed along the radial wall 536, particularly along the axial surface 538.

In the exemplary embodiment shown in FIG. 7, the seal block 530 includes an extension arm 570. The extension arm 570 includes a radial portion 572 that extends outwardly in the radial direction 116 from a radially outer surface 574 of the seal block 530. The extension arm 570 also includes an axial portion 576 that extends axially with respect to axial direction A towards the inner surface 140 of the backing plate 118. The backing plate 118 includes or defines a spring support tab 166. The spring support tab 166 is positioned radially inward from the axial portion 576 of the extension arm 570 with respect to radial direction 116. The spring support tab 166 also extends axially with respect to axial direction A from the inner surface 140 towards the radial portion 572 of the extension arm 570. A spring member 578 extends between the spring support tab 166 and the axial portion 576 of the extension arm 570 such that the spring member biases the seal block away from the rotor.

In the embodiment shown in FIG. 7, the rotor 104 defines the rotor fluid passage 160 and at least partially defines the inner rotor cavity C3. The rotor fluid passage 160 provides for fluid communication between the inner rotor cavity C3 and the radial gap R_{G} defined between the radial load-bearing surface 526 and the outer surface 154 of the rotor 104. The inner rotor cavity C3 provides rotor seal air 162 to the rotor fluid passage 160 and to the radial gap R_{G} at the inner rotor supply pressure P_{RS} that is higher than the higher-pressure fluid P_{H} in the first pressure cavity C1 and the lower-pressure fluid P_{L} in the second pressure cavity C2. This typically means that a ratio P_{RS}/P_{H} can range from low values of the order of 1 (example P_{RS}/P_{H} ratio 1.5) through high values such of the order of 10 (example P_{RS}/P_{H} ratio 30). The inner rotor cavity C3 may receive the rotor seal air 162 from the gas turbine engine 10 (FIG. 1) such as, but not limited to, one or more of the high-pressure compressor 40, the low-pressure compressor 38, the high-pressure turbine 42, and the low-pressure turbine 44, as shown in FIG. 1.

In operation, as shown in FIG. 7, the inner rotor cavity C3 is charged with the rotor seal air 162 at the inner rotor supply pressure P_{RS} by one or more of the high-pressure compressor 40, the low-pressure compressor 38, the high-pressure turbine 42, and the low-pressure turbine 44. The rotor seal air 162 flows from the inner rotor cavity C3 through the rotor fluid passage 160 and is exhausted via rotor seal outlet 164 of the rotor fluid passage 160 between the radial load-bearing surface 426 and the outer surface 154 of the rotor 104 to allow the seal block 430 (and the seal assembly 100) to float above the outer surface 154 of the rotor 104 while maintaining a radial seal and the minimum radial gap R_{G} between the seal assembly 100 and the rotor 104. The minimum radial gap R_{G} acts to avoid wear of the seal block 430 against the outer surface 154 of the rotor 104. The rotor seal air 162 at the inner rotor supply pressure P_{RS} prevents or reduces passage of the higher-pressure fluid P_{H} through the radial gap R_{G} from the first pressure cavity C1 to the second pressure cavity C2.

As shown in FIG. 7, a portion of the rotor seal air 162 enters the fluid passage 542 of the seal block 530 via inlet 544 and is exhausted from the hydrostatic port 566 between the axial surface 538 and the inner surface 140 of the backing plate, thereby forming an axial film-bearing seal 568 therebetween. The axial film-bearing seal 568 may also be referred to as an axial seal. The axial film-bearing seal 568 further prevents or reduces passage of the higher-pressure fluid P_{H} from the first pressure cavity C1 to the second pressure cavity C2 between the radial wall 536 and the inner surface 140 of the backing plate 118.

The spring member 578 may be loaded in compression providing a biasing spring force that pulls the seal block away from the rotor when pressurizing fluid is absent. Thus, in the absence of differential pressure across the C1 and C2 cavities, the seal block stays radially further away from the rotor. Upon pressurization, the higher-pressure fluid P_{H} exerts a radially inward acting force (herein referred as R_{IF} in FIG. 7) against the radially outer surface 574 of the seal block 530 and pushes the seal towards the rotor and ride separated at a radial gap R_{G} from the rotor.

It should be noted that whereas the embodiments shown in FIG. 3 and FIG. 4 have physical contact between the respective seal block 130, 230 and the respective backing plate 118, for the embodiments disclosed in FIGS. 5, 6, and 7, the recessed axial surface 338 fills up or is pressurized with the seal air 150 from the respective hydrostatic port 366, 466, and 566 and forms an air film that levitates the respective seal block 330, 430, 530 against the backing plate 118, thus forming an axial gap A_{G} therebetween. In other words, because of the pressurization within the recess of the axial surface 338 (FIGS. 5-7), there is a non-physical contact situation between the respective seal block 330, 430, 530 and the backing plate 118.

The radial seal assembly described herein improves stage-to-stage gas leakage performance in either a compressor section or a turbine section of a gas turbine engine and results in overall fuel consumption benefits. The radial seal assembly utilizes at least one additional gas supply which provides supply air, or in certain embodiments, rotor supply air, at a higher pressure than the pressure of the upstream high-pressure gas to form the radial film riding seal. The supply air or the rotor supply air, also forms an axial film-bearing seal. These film riding seals may track the rotor at precise running gaps at various engine cycles to accommodate the rotor's centrifugal growth and vibration.

Further aspects are provided by the subject matter of the following clauses:

A radial film-riding seal assembly for a rotary machine having a core air flowpath, the radial film-riding seal assembly comprising: a rotor defining an outer surface; a seal air supply; and a seal assembly disposed within the core air flowpath, wherein the seal assembly sub-divides the core air flowpath into a first pressure cavity pressurized at a first pressure, and a second pressure cavity pressurized at a second pressure, wherein the first pressure is higher than the second pressure, the seal assembly comprising a plurality of seal segments circumferentially arranged about the outer surface of the rotor, each seal segment comprising: a seal block defining a radial load-bearing surface, an axial surface, a hydrostatic port defined along the radial load-bearing surface, and a fluid passage, wherein a radial gap is defined between the radial load-bearing surface and the outer surface of the rotor, wherein the fluid passage is fluidly coupled to the seal air supply and in fluid communication with the hydrostatic port, wherein the seal air supply is configured to supply a seal air to the fluid passage, wherein the seal air is at a higher pressure than the first pressure and the second pressure.

The radial film-riding seal assembly of the preceding or any following clauses, wherein the fluid passage is fluidly coupled to the seal air supply via a tube extending from a radially outer surface of the seal block.

The radial film-riding seal assembly of any preceding or following clause, wherein the first pressure cavity is defined immediately upstream from the seal assembly and the second pressure cavity is defined immediately downstream from the seal assembly.

The radial film-riding seal assembly of any preceding or following clause, wherein seal assembly includes a backing plate defining an inner surface disposed axially adjacent to and in contact with the axial surface of the seal block.

The radial film-riding seal assembly of any preceding or following clause, wherein an axial air bearing is formed between the seal block and the backing plate.

The radial film-riding seal assembly of any preceding or following clause, wherein the axial load-bearing surface defines a chordal bump, wherein the chordal bump is in contact with the backing plate.

The radial film-riding seal assembly of any preceding or following clause, further comprising a stator, wherein the seal assembly includes a front cover plate, a top plate, and a backing plate, wherein the top plate defines a stator interface surface, wherein the stator interface surface is attached to the stator, wherein the rotary machine is a gas turbine engine.

A radial film-riding seal assembly for a rotary machine having a core air flowpath, the radial film-riding seal assembly comprising: a rotor defining an inner rotor cavity, an outer surface, and a rotor fluid passage, wherein the rotor fluid passage includes a rotor seal outlet defined along the outer surface, wherein the rotor fluid passage provides for fluid communication from the inner rotor cavity and through the rotor seal outlet; and a seal assembly disposed within the core air flowpath, wherein the seal assembly sub-divides the core air flowpath into a first pressure cavity and a second pressure cavity, the seal assembly comprising a plurality of seal segments circumferentially arranged about the outer surface of the rotor, each seal segment comprising: a seal block defining a radial load-bearing surface and an axial surface, wherein a radial gap is defined between the radial load-bearing surface and the outer surface of the rotor, wherein the rotor seal outlet of the rotor fluid passage is disposed beneath the radial load-bearing surface.

The radial film-riding seal assembly of the preceding clause, wherein the first pressure cavity is defined within the core air flowpath immediately upstream from the seal assembly and the second pressure cavity is defined immediately downstream from the seal assembly, wherein the first pressure cavity is pressurized with a higher-pressure fluid, and the second pressure cavity is pressurized with a lower-pressure fluid compared to the higher-pressure fluid, and wherein the inner rotor cavity is configured to provide a rotor seal air to the rotor fluid passage at a rotor supply pressure that is higher than the higher-pressure fluid in the first pressure cavity and the lower-pressure fluid in the second pressure cavity.

The radial film-riding seal assembly of any preceding or following clause, wherein the seal block includes a radial wall including a chordal bump, wherein the chordal bump at least partially defines the axial surface.

The radial film-riding seal assembly of any preceding or following clause, wherein the seal block defines an elongated recess, and wherein the seal assembly includes a biasing element disposed within the elongated recess.

The radial film-riding seal assembly of any preceding or following clause, wherein the seal assembly further includes a backing plate defining an inner surface, wherein the seal block defines a fluid passage, and a hydrostatic port defined along the axial surface and oriented towards the inner surface of the backing plate, wherein the fluid passage is in fluid communication with the hydrostatic port.

The radial film-riding seal assembly of any preceding or following clause, further comprising a seal air supply, wherein the fluid passage is fluidly coupled to the seal air supply via a tube extending from a radially outer surface of the seal block.

The radial film-riding seal assembly of any preceding or following clause, wherein the seal block defines an inlet disposed along the radial load-bearing surface, wherein the inlet provides for fluid communication of a portion of a rotor seal air from the rotor seal outlet to the hydrostatic port.

The radial film-riding seal assembly of any preceding or following clause, wherein the seal block further includes an extension arm having a radial portion extending radially outwardly from a radially outer surface of the seal block, and an axial portion extending towards the inner surface of the backing plate, wherein the seal block is engaged with the backing plate via a spring member.

The radial film-riding seal assembly of any preceding or following clause, wherein the backing plate includes a spring support tab extending from the inner surface towards the seal block, and wherein the spring member extends radially between the spring support tab and the axial portion of the extension arm.

A gas turbine engine having a core air flowpath, the gas turbine engine comprising: a rotor defining an inner rotor cavity, an outer surface, and a rotor fluid passage, wherein the rotor fluid passage includes a rotor seal outlet defined along the outer surface, wherein the rotor fluid passage provides for fluid communication from the inner rotor cavity and through the rotor seal outlet; and a seal assembly disposed within the core air flowpath, wherein the seal assembly sub-divides the core air flowpath into a first pressure cavity and a second pressure cavity, wherein the first pressure cavity is defined within the core air flowpath immediately upstream from the seal assembly and the second pressure cavity is defined immediately downstream from the seal assembly, wherein the first pressure cavity is pressurized with a higher-pressure fluid, and the second pressure cavity is pressurized with a lower-pressure fluid compared to the higher-pressure fluid, wherein the seal assembly includes a plurality of seal segments circumferentially arranged about the outer surface of the rotor, each seal segment comprising: a seal block defining a radial load-bearing surface and an axial load-bearing surface, wherein a radial gap is defined between the radial load-bearing surface and the outer surface of the rotor, wherein the rotor seal outlet of the rotor fluid passage is disposed beneath the radial load-bearing surface, and wherein the inner rotor cavity is configured to provide a rotor seal air to the rotor fluid passage at a rotor supply pressure that is higher than the higher-pressure fluid in the first pressure cavity and the lower-pressure fluid in the second pressure cavity.

The gas turbine engine of the preceding or any following clause, wherein the seal block includes a radial wall including a chordal bump, wherein the chordal bump at least partially defines the axial load-bearing surface.

The gas turbine engine of any preceding or following clause, wherein the seal assembly further includes a backing plate defining an inner surface, wherein the seal block defines a fluid passage and a hydrostatic port defined along the axial surface and oriented towards the inner surface of the backing plate, wherein the fluid passage is in fluid communication with the hydrostatic port and a seal air supply, wherein the fluid passage is fluidly coupled to the seal air supply via a tube extending from a radially outer surface of the seal block.

The gas turbine engine of any preceding or following clause, wherein the seal block defines an inlet disposed along the radial load-bearing surface, wherein the inlet provides for fluid communication of a portion of the rotor seal air from the rotor seal outlet to the hydrostatic port.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A radial film-riding seal assembly for a rotary machine having a core air flowpath, the radial film-riding seal assembly comprising:
a rotor defining an outer surface;
a seal air supply; and
a seal assembly disposed within the core air flowpath,
wherein the seal assembly sub-divides the core air flowpath into a first pressure cavity pressurized at a first pressure, and a second pressure cavity pressurized at a second pressure,
wherein the first pressure is higher than the second pressure, the seal assembly comprising a plurality of seal segments circumferentially arranged about the outer surface of the rotor, each seal segment comprising:
a seal block defining:
a radial load-bearing surface,
an axial surface,
a hydrostatic port, and
a fluid passage,
wherein a radial gap is defined between the radial load-bearing surface and the outer surface of the rotor,
wherein the fluid passage is fluidly coupled to the seal air supply and in fluid communication with the hydrostatic port,
wherein the seal air supply is configured to supply a seal air to the fluid passage,
wherein the seal air is at a higher pressure than the first pressure and the second pressure.

2. The radial film-riding seal assembly of claim 1, wherein the fluid passage is fluidly coupled to the seal air supply via a tube extending from a radially outer surface of the seal block.

3. The radial film-riding seal assembly of claim 1, wherein the first pressure cavity is defined immediately upstream from the seal assembly and the second pressure cavity is defined immediately downstream from the seal assembly.

4. The radial film-riding seal assembly of claim 1, wherein seal assembly includes a backing plate defining an inner surface disposed axially adjacent to and in contact with the axial load-bearing surface of the seal block.

5. The radial film-riding seal assembly of claim 4, wherein an axial air bearing is formed between the seal block and the backing plate.

6. The radial film-riding seal assembly of claim 1, further comprising a stator, wherein the seal assembly includes a front cover plate, a top plate, and a backing plate, wherein the top plate defines a stator interface surface, wherein the stator interface surface is attached to the stator, wherein the rotary machine is a gas turbine engine.

7. A radial film-riding seal assembly for a rotary machine having a core air flowpath, the radial film-riding seal assembly comprising:
a rotor defining:
an inner rotor cavity,
an outer surface, and
a rotor fluid passage,
wherein the rotor fluid passage includes a rotor seal outlet defined along the outer surface,
wherein the rotor fluid passage provides for fluid communication from the inner rotor cavity and through the rotor seal outlet; and
a seal assembly disposed within the core air flowpath,
wherein the seal assembly sub-divides the core air flowpath into a first pressure cavity and a second pressure cavity, the seal assembly comprising a plurality of seal segments circumferentially arranged about the outer surface of the rotor, each seal segment comprising:
a seal block defining a radial load-bearing surface and an axial surface,
wherein a radial gap is defined between the radial load-bearing surface and the outer surface of the rotor,
wherein the rotor seal outlet of the rotor fluid passage is disposed beneath the radial load-bearing surface.

8. The radial film-riding seal assembly of claim 7, wherein the first pressure cavity is defined within the core air flowpath immediately upstream from the seal assembly and the second pressure cavity is defined immediately downstream from the seal assembly,
wherein the first pressure cavity is pressurized with a higher-pressure fluid, and the second pressure cavity is pressurized with a lower-pressure fluid compared to the higher-pressure fluid, and
wherein the inner rotor cavity is configured to provide a rotor seal air to the rotor fluid passage at a rotor supply pressure that is higher than the higher-pressure fluid in the first pressure cavity and the lower-pressure fluid in the second pressure cavity.

9. The radial film-riding seal assembly of claim 7, wherein the seal block includes a radial wall including a chordal bump, wherein the chordal bump at least partially defines the axial surface.

10. The radial film-riding seal assembly of claim 7, wherein the seal block defines an elongated recess, and wherein the seal assembly includes a biasing element disposed within the elongated recess.

11. The radial film-riding seal assembly of claim 7, wherein the seal assembly further includes a backing plate defining an inner surface, wherein the seal block defines a fluid passage and a hydrostatic port defined along the axial surface and oriented towards the inner surface of the backing plate, wherein the fluid passage is in fluid communication with the hydrostatic port.

12. The radial film-riding seal assembly of claim 11, further comprising a seal air supply, wherein the fluid passage is fluidly coupled to the seal air supply via a tube extending from a radially outer surface of the seal block.

13. The radial film-riding seal assembly of claim 11, wherein the seal block defines an inlet disposed along the radial load-bearing surface, wherein the inlet provides for fluid communication of a portion of a rotor seal air from the rotor seal outlet to the hydrostatic port.

14. The radial film-riding seal assembly of claim 11, wherein the seal block further includes an extension arm having a radial portion extending radially outwardly from a radially outer surface of the seal block, and an axial portion extending towards the inner surface of the backing plate, wherein the seal block is engaged with the backing plate via a spring member.

15. The radial film-riding seal assembly of claim 14, wherein the backing plate includes a spring support tab extending from the inner surface towards the seal block, and wherein the spring member extends radially between the spring support tab and the axial portion of the extension arm.

16. A gas turbine engine having a core air flowpath, the gas turbine engine comprising:
a rotor defining an inner rotor cavity, an outer surface, and a rotor fluid passage, wherein the rotor fluid passage includes a rotor seal outlet defined along the outer surface, wherein the rotor fluid passage provides for fluid communication from the inner rotor cavity and through the rotor seal outlet; and
a seal assembly disposed within the core air flowpath,
wherein the seal assembly sub-divides the core air flowpath into a first pressure cavity and a second pressure cavity,
wherein the first pressure cavity is defined within the core air flowpath immediately upstream from the seal assembly and the second pressure cavity is defined immediately downstream from the seal assembly,
wherein the first pressure cavity is pressurized with a higher-pressure fluid, and the second pressure cavity is pressurized with a lower-pressure fluid compared to the higher-pressure fluid,
wherein the seal assembly includes a plurality of seal segments circumferentially arranged about the outer surface of the rotor, each seal segment comprising:
a seal block defining a radial load-bearing surface and an axial surface,
wherein a radial gap is defined between the radial load-bearing surface and the outer surface of the rotor,
wherein the rotor seal outlet of the rotor fluid passage is disposed beneath the radial load-bearing surface, and
wherein the inner rotor cavity is configured to provide a rotor seal air to the rotor fluid passage at a rotor supply pressure that is higher than the higher-pressure fluid in the first pressure cavity and the lower-pressure fluid in the second pressure cavity.

17. The gas turbine engine of claim 16, wherein the seal block includes a radial wall including a chordal bump, wherein the chordal bump at least partially defines the axial load-bearing surface.

18. The gas turbine engine of claim 16, wherein the seal assembly further includes a backing plate defining an inner surface, wherein the seal block defines a fluid passage and a hydrostatic port defined along the axial load-bearing surface and oriented towards the inner surface of the backing plate, wherein the fluid passage is in fluid communication with the hydrostatic port and a seal air supply, wherein the fluid passage is fluidly coupled to the seal air supply via a tube extending from a radially outer surface of the seal block.

19. The gas turbine engine of claim 18, wherein the seal block defines an inlet disposed along the radial load-bearing surface, wherein the inlet provides for fluid communication of a portion of the rotor seal air from the rotor seal outlet to the hydrostatic port.
